(19) United States
(12) Patent Application Publication
(10) Pub. No.: US 2019/0065038 A1
(43) Pub. Date: Feb. 28, 2019

(54) Algorithmically Assisted Design System

(71) Applicant: Adam Wilner, Studio City, CA (US)

(72) Inventor: Adam Wilner, Studio City, CA (US)

(21) Appl. No.: 15/991,944

(22) Filed: May 29, 2018

Related U.S. Application Data
(60) Provisional application No. 62/511,735, filed on May 26, 2017.

(51) Int. Cl. G06F 3/0484; G06F 17/24; G06F 17/21

(52) U.S. Cl. CPC G06F 3/04847; G06F 17/214; G06F 17/24

(57) ABSTRACT

The present invention is a comprehensive digital design system that makes it possible for a person with any level of design experience, including minimal or no experience to create a unique design in any digital or printed medium, driven by the User's desired design aesthetic, using an interface that requires no technological expertise beyond the operation of basic interface controls, and that requires no design background, hut that is equally useful to the most advanced users.

### CROSS-REFERENCE TO RELATED APPLICATION

This patent application claims the benefit of U.S. Provisional Patent Application Ser. Number 6/511,735, entitled “Automated Digital Design System,” filed May 26, 2017, which is incorporated in its entirety here by this reference.

### TECHNICAL FIELD

The present invention relates to Digital Design in all visual media for Users with any level of design experience, including no design background.

### BACKGROUND

Design technology that is geared to help non-designers create designs (e.g. websites, print design, and any other visual design in 2D or 3D) currently either requires design and technology experience, or relies heavily on template-based systems that have limited potential for customization. Presently available software systems and computer/device applications do not enable Users to have full control over the look of their desired design without requiring high degrees of knowledge in the realm of design aesthetics, and/or time-consuming acquisition of skills relating to a complex design interface.

The present invention solves this problem by providing a design system that generates an abundance of algorithmically assembled initial designs relevant to aesthetic choices expressed by the User, and then provides an interface that enables the User to explore a universe of design possibilities using simple controls, which contain within them contextual access to progressively more refined control. The User thus has full control over the end-product design using a system and interface that is at once simple to use and yet provides the finest granularity of graphical control.

### SUMMARY

The present invention is a comprehensive digital design system, “Algorithmically Assisted Design System,” “AADS,” that makes it possible for a person with any level of design experience, including minimal or no experience, “User,” to create a unique design in any digital or printed medium, driven by the User's desired design aesthetic, using an interface that requires no technological expertise beyond the operation of basic interface controls, and that requires no design background, but that is equally useful to the most advanced Users.

The User starts with a comprehensive search tool to initially find design candidates that snatch their general desired aesthetic. These starting-point designs have been manufactured by automated systems. The User then has the ability to refine any chosen design candidate to a very refined degree using simple controls with progressively finer embedded controls, accessed only as desired, and all prefigured with design possibilities that have been Algorithmically predetermined to be aesthetically consonant.

### BRIEF DESCRIPTION OF DRAWINGS

FIG. 1 shows one embodiment of the interface and control panel;

FIG. 2 shows an example of a header design with a design element box around it;

FIG. 3 shows an example of a header on a webpage;

FIG. 4 shows another example of a header on a webpage;

FIG. 5 shows an attribute selector page;

FIG. 6 shows a series of thumbnails of design candidates;

FIG. 7 shows an example of the control panel;

FIG. 8 shows another example of the control panel;

FIG. 9 shows the control panel with varied controls;

FIG. 10 shows a fader on the control panel for manipulating fonts;

FIG. 11 shows an embodiment of the interface and control panel;

FIG. 12 shows the control panel with varied controls;

FIG. 13 shows an embodiment of the control panel;

FIG. 14 shows an embodiment of the control panel with page element selections; and

FIG. 15 shows an embodiment of the control panel.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The challenge of creating a comprehensive digital design system that gives both flexible, advanced functionality commensurate with the most sophisticated design technologies, and yet also provides a User Interface that is useful to the full spectrum of expertise, from beginning through advanced Users wishing to create a design, requires a novel approach to User experience, and the underlying system. Accordingly, we have set down some guiding principles for the invention.

The AADS is governed by 5 key principles of the User's experience:

1. The user is able to specify desired aesthetic qualities of the design they are undertaking as though they were working with a human designer, and then be presented by the system with “starter designs” or initial design candidates that they can then further refine.

2. All refinements and manipulations of any design by the User, at least in the initial or default mode, are constrained to look good—i.e. the design interface controls allow the user in the initial mode, modality, to cause changes to the design elements that fall within “best practices of design,” or within the bounds of what designers would generally agree are aesthetically pleasing.

3. The User is always operating in “preview mode”—i.e. While designing, the user is never in an “edit mode,” where there are distracting lines that delineate sections, lines, boxes, etc. Instead, the User is always manipulating the design elements while looking at essentially the finished product without any visual distraction.

4. At the default level, or starting point, of any Design Element manipulation using the AADS interface, the possible manipulations that are provided to the User are given in very simple controls, which are geared to manipulate multiple attributes, and possibly alter multiple

Elements, at once, such that even a User with no prior design or technology experience could easily effect meaningful and aesthetically pleasing or consonant design changes, and a User that does have more advanced design and technology background can rapidly explore an extensive palette of design choices.

5. That all these “simple controls” (from point 4 above) found at the starting point of any design element manipulation, have contextual interface controls that easily reveal more advanced and more refined controls that were originally mapped to the simple or starting point

controls, ensuring that advanced Users will find the detailed control over the design that they would expect from professional design software, and somewhat adventurous beginning Users can find their way to more granular control.

Taxonomy of Design Elements

In order to realize the vision of this User Experience, the present invention, AADS, has been constructed by approaching design from the standpoint of flexible assembly of constituent design elements which are qualified and quantified. All design elements of any type (e.g. those that comprise a webpage) such as header area, header text, body text, image, logo, footer area, background, color scheme, font scheme, or any other design constituent, or indeed the overall structural architecture or schematic of the page or other enclosing construct, herein “Element,” of any design object in any digital or printed medium, such as website, web page, business card, flyer, brochure, newsletter, or any other visual 2D or 3D medium, herein “Object,” are categorized and organized in a database. The database contains quantitative data about each Element, such as dimensions, roundness of corners, or any other attributes, as well as qualitative data about each Element, such as stylistic or aesthetic labels or values.

Additionally—and this a key aspect to AADS—every instance of every design element is categorized according to the ways in which it can be interchanged with other Elements and Instances.

This principle of interchangeability of elements sets the table for the key novel innovations contained in AADS. In one embodiment initial designs are created exclusively by assembling Elements through algorithmic processes that determine both qualitative and quantitative compatibility of various Elements.

This process has several major advantages: 1) Allows for the automated pre-assembly of a large number of designs. 2) Facilitates searches for initial designs based on design criteria provided by User, and allows for rapid presentation of a large quantity of search results. 3) Facilitates a consistent User interface that gives full and free control over each Element.

The 4 Subsystems of AADS

The key inventions of the Design System are A) the method by which we achieve aesthetic coordination among freely interchangeable design Elements, and B) the very flexible interface that gives the User the ability to explore some initial broad strokes of design Element variation, and then to “drill in” and explore variations at a finer degree of granularity, by accessing contextually located secondary and dependent Controls that are revealed as User wishes. This hierarchical system of Controls, which initially only reveals simple and larger design Controls, and then allows for the revelation of successively more detailed Controls gives the User the ability to operate in a very simple design environment if preferred, but also provides the User ever-increasingly refined control over design choices.

The Design System facilitates this experience for the User by coordination of 4 Subsystems:

1. Database of coordinated design variations for all possible Elements and a system of logic for interchange of various Elements;

2. Automated Design Manufacture;

3. Design Attribute-Based Search;

4. Interface that allows easy exploration by User, but that facilitates contextual “drilling in” to greater detail, using nested iterations of the interface.

Here we will describe in greater detail these 4 principal concepts:

1. Database of Design Element Variations and System of Logic for Interchange of

Elements In order to provide the User with a guided and complete aesthetically coordinated universe of design Elements, it is necessary to establish a database that identifies a number of attributes, both qualitative and quantitative, for each category of, and each instance of, a design Element.

The Design System first defines the possible constituent categories of Elements of any design paradigm. For example, in the case of a website, there are a finite number of categories of Elements of the design, and each category has its own set of Elements. As an example, a website design has an overall design structure or wireframe architecture, a header area, one or multiple menu area(s), perhaps a sidebar area, a body area, a footer area, a box, button, and border shape aesthetic, a text aesthetic, and a color aesthetic, and possibly other Elements.

All of these constituent regional Elements can be considered, designed, arid developed independently, and then used interchangeably to provide a far greater field of possibilities. Many header designs, for example, can be plausibly interchanged with other header designs inside of a given website design.

The database underlying AADS facilitates this interchangeability of Elements in an aesthetically agreeable way on a reliable basis. Included in this database are codes to identify an array attributes of the Elements, such as the physical dimensions of height and width, and any other structural information, such as thickness of borders or roundness of corners if any, as well as cultural and aesthetic evaluations, such as “Avant-Garde” or “Conservative.”

A rich and full database of design Elements and their qualitative and quantitative identities allows for a sophisticated assembly of these Elements in endless combinations, creating unique designs algorithmically without human guidance.

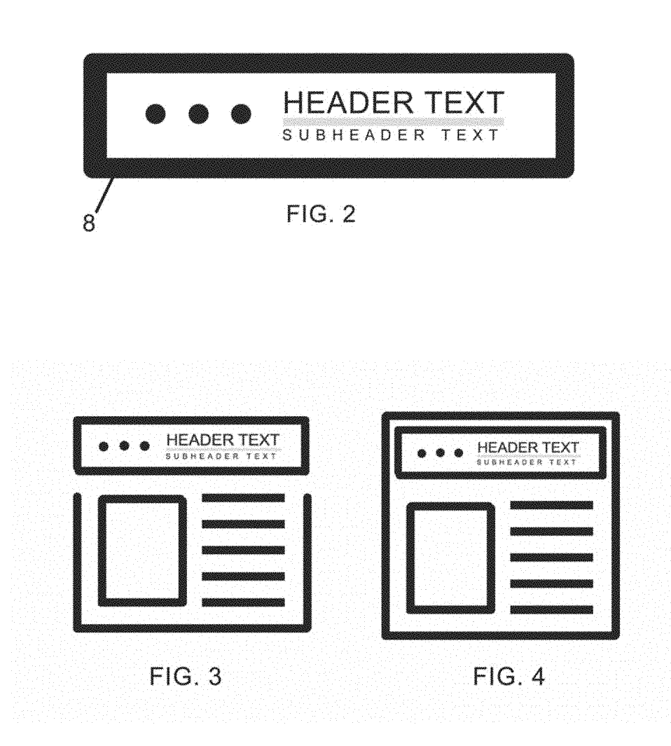

All Elements in AADS are part of a hierarchical organization that helps keep track of how Elements may be used together—or not—as part of a larger design. A certain header design, for example, may work fine in certain design architectures, but not in others. If a given header FIG. 2 has as a design element a box around it [8], that whole header design would look fine in a design that does NOT have background structures that would conflict with a boxed-in header FIG. 3, but in other background structures FIG. 4 a box around the header would be redundant and aesthetically dissonant. We therefore register this header as having an attribute of being in a header box.

It is then up to a cross-relational database table that contains equations that determine compatibility across a range of considerations. This matrix of compatibility considers both structural and aesthetic attributes of compatibility. In the above example compatibility is a question of structure. But there would also be cases of more qualitative aesthetic compatibility considerations. An Element that has a distinctly “Art Deco” appearance would never want to be paired with other Elements that have inherent styles that would be unsympathetic aesthetically to “Art Deco.”

The individual Elements are stored in the database with a great deal of information to them. Many Elements consist of, but are not limited, to HTML/CSS constructs, but they may also have physical graphical Elements such as PNG's or JPEG's, or other graphical formats which in the final product are stored in cloud (i.e. universally available) servers for instantaneous use by any instance of the Design System in the physical world. Individual Elements stored in the database are not simply single objects. They must contain all possible ranges of values that would be applied to Controls in the interface of the Design System. Additionally they must contain ranges of values to account for varying form factors, such as mobile, tablet, or desktop manifestations.

In essence, each individual Element is a multi-dimensional object of possibilities. There is no arbitrary limit to the number of ranges nor that limit the values attributable to the value ranges.

When one considers the possibility of the creation of an ever-growing body of design elements, and the innumerable ways in which they may be combined, and the innumerable ways in which they may be altered unto themselves, we clearly see the potentiality for an extraordinarily large number of designs. Furthermore, in AADS a given design is, in essence, the sum total of Elements and the particular settings of all of their attributes. Designs in AADS can be defined strictly in terms of the settings of all of the attributes of all of the design elements in any design. Therefore it can be stated again that in one embodiment all designs in AADS exist on a continuum of designs, and that any design can be arrived at from the starting point of any other design simply by use of the interface and its Controls.

Several additional benefits this system of design by way of algorithmic assembly of elements are: A) It facilitates an automated design manufacture system that can produce very large numbers of designs that cover virtually all imaginable styles, stylistically unified unto themselves and B) On the User's side, it permits the creation of a system wherein the User can express desired attributes for a design and have design candidates presented that reflect those desired attributes.

2. Automated Design Manufacture

A major part of AADS is the facility by which the User can specify certain desired design attributes and be presented with a large multitude of starting design candidates that reflect those choices. We therefore need to assemble designs beforehand, and keep track of what qualitative attributes they possess.

In AADS, we automate the assembly of completed designs in large numbers, bringing together design Elements in an automated fashion, with every possible combination of attribute settings across the set of attributes that we have set up, into complete designs.

Drawing on the database of design Elements and using the system of compatibility logic outlined in the section above, we are able to programmatically iterate through all possible combinations of Elements, simultaneously iterating through different combinations of qualitative aesthetic settings as may be described by the User in the search interface (see next section).

Upon each assembly, the iterative program saves that completed design, creates a thumbnail of the design, and saves with it codes representing the settings along the axes (or range) of all of the attributes of all of the Elements. All graphical Elements such as thumbnails are stored in the cloud, and the database is available to all instances of Design System. Designs may be reviewed by human administrators.

This system of design automation also presents us with the ability to save sets of designs for individual purposes, sectors, industries, or other “niches.” For example, using this design automation functionality of AADS, designs for a particular profession, for example “lawyers,” could be generated by the assembly program. In setting up the assembly of this niche, administrators would make certain that only design elements with the qualitative aesthetic labels and qualities consistent with the needs of the legal profession would be used. The program could further be set to only use boilerplate graphical elements, such as gavels or classical building columns, courtrooms, etc., i.e. images appropriate for designs for the legal profession, to be incorporated into that particular design set.

3. Design Attribute-Based Search

When a User is first approaching the acquisition of a new design, in a normal design setting with a human designer, the User would express desired attributes of the design: The User might say, “I would like the design to be very simple but very modern looking, with bright colors and bold fonts.” This invention seeks to provide technologically and in an automated environment the ability to arrive at desired design candidates based on those kinds of attribute selections.

To accomplish this same experience in an automated setting, we provide the User with an interface to declare the desired attributes of a design, and then we bring forward designs that most closely match those stated desired attributes.

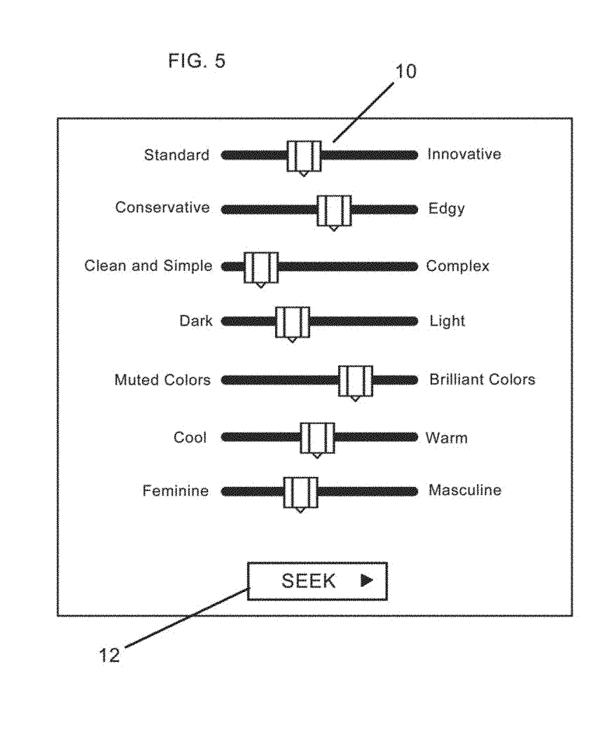

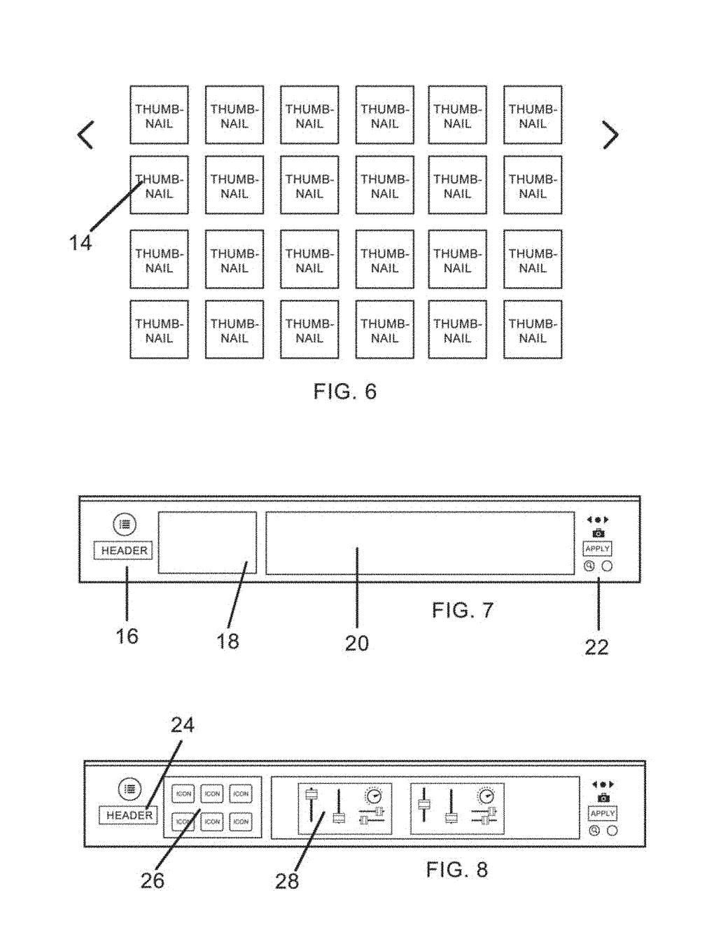

Upon arrival in our AADS, in one embodiment the User will begin by selecting attributes from an attribute selector page, FIG. 5. In one instance of this system this will be accomplished by a set of faders [10], but other interface ideas may serve as well (individual buttons, knobs, dials, or perhaps a survey of aesthetic questions, etc.). The User then initiates a search of existing designs that have been automatically generated by clicking a submit button [12], whereupon the search algorithm will bring forward thumbnails of design candidates FIG. 6 [14], that adhere most closely to the set of design attributes selected by the User.

To take an example, let us suppose that in a given instance of AADS, we have settled on 7 aesthetic attributes that the User will be asked to specify. Each attribute, e.g. “Brightness,” or “Color Brilliance,” will be placed along a spectrum,or “axis” in which the User can then set a desired value for that attribute.

The axes may be expressed as increments ranging from 0 to 9, for example. So the User may choose to have a very light site, which in this instance would be registered as a high number such as an “8,” along a “Dark/Light” axis, and may choose for the design to have muted colors, which in this instance would register as a low number, for example “2,” along an axis identified as “Muted/Brilliant.” The full string of these numbers, which represent points along an axis of all 7 of the attribute pairs, can be expressed as a single string of 7 numbers, such as “2856535,” We can call this number the Attribute ID, or the AID. All of the preassembled, automatically created designs in the AADS also have an AID number, which is derived from the cumulative, weighted score of each of the constituent elements that were algorithmically and somewhat randomly selected. The search algorithm upon the User's choice submission would then compare the User's chosen AID, to the AID numbers associated with each of the many stored and automatically created designs, and bring up the designs that are the closest match.

In another instance of this system, we may also provide an “importance” setting for each attribute, so that the User can identify certain attributes as being more important than others. For example it may be very important to the User that the site be light, but the User may be less concerned about setting the brilliance of the colors in advance of receiving the first set of design candidates.

In any event, the User will be able to either return to the attribute selector page and refine the settings, and get more design candidates, or the User may select a thumbnail which would then bring up that design and immediately provide the User with the environment to begin refining the design of that site.

4. User Interface

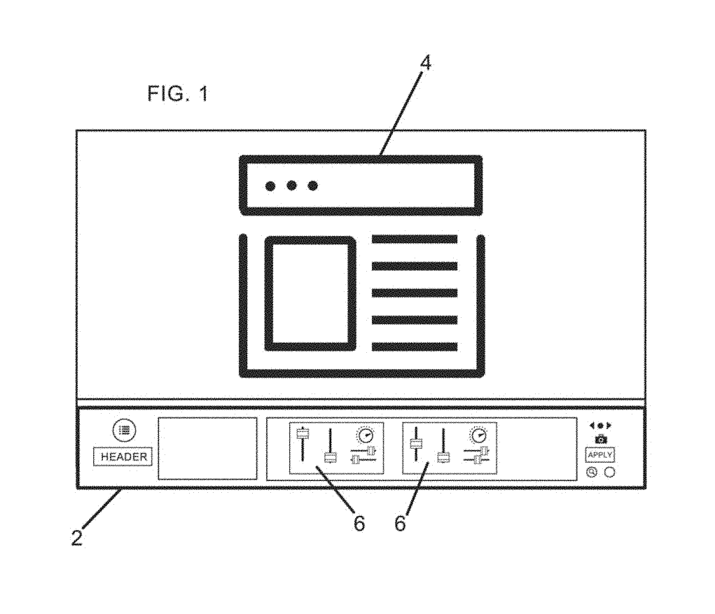

AADS uses, in the examples herein, a web browser as the medium for its interface and programming, but is not limited thereto. The basic construct of the Interface of AADS is that there is a panel, “Panel,” FIG. 1, [2] which sits adjacent to, on any side, preferably along the bottom of the design object [4]. The Panel contains instruments,[6], such as faders, buttons, knobs, wheels, switches, or any other instrument that can be used by a User to manipulate attributes of design, herein “Controls.” [Note: Although we use “fader” frequently as an example in this patent, any other instrument such as needle, dial, knob, wheel, joystick or even mechanical controllers without limitation may be substituted.] The Controls directly change the values of any and all attributes of the Elements of the design of the Object visibly, instantly, and in a WYSIWYG manner, but always in an aesthetically coordinated way, 1 such that ideally every design change the User makes is reviewable and aesthetically positive.

One key innovation of the interface is the principal that the User, when focusing on any given design Element, should be first provided, in the Control section of the Panel with one or a few simple Controls which when manipulated by the User cause broad changes across multiple attributes of the design Element the User is focused on, offering aesthetically coordinated design choices for that design Element, but that these initial simple Controls come equipped with the option to reveal contextually to the User more detailed Controls over the individual Elements that comprise that initial simple Control.

This interface system makes it possible for Users who prefer to operate only using a simple interface to arrive at algorithmically constructed broad strokes of design choices to do so without ever encountering the clutter of more complex and detailed interfaces. But if the User wishes, the ability is available right there to “drill in” contextually without leaving the modality of that initial interface, giving the User the ability to control the design of that Element potentially down to the finest level of design.

Furthermore, because designs may be created exclusively by way of assembling elements through algorithmic processes from a database, and because all of these attributes are mapped to individual controls at the finest level of granularity, in essence this is a comprehensive system wherein the User could start from any one design and arrive at any other design, possibly an entirely different design, simply by the use of this interface which requires no design expertise or other technological knowledgeability.

While it is possible to use AADS to arrive at any design. Users may be unlikely to be so adventurous or confident in their design sense as to find their way simply by exploration of controls. Therefore the Design System enables the User to search for a starting point for the design of the Object by declaration of desired attributes, and then allows easy exploration of different design possibilities of individual Elements therein such that all possibilities presented to the User are aesthetically coordinated, and is done so using an interface THAT is so simple and intuitive that no training is required, with the full expectation that the end result will be a well-designed and unified Object. But the User can always return to the search interface and look for a new starting point of the design. It is an important point that the “starting point” of any design is ultimately a particular setting of attributes of the various elements of that design.

In other words, this is a self-contained universe of a design system, and all designs exist along a potentially infinite continuum of possible configurations, provided that the assets of design elements are continually expanded.

This invention solves the fundamental problem of providing the User with a platform to manipulate design without requiring great design expertise, by a system of Controls that in their initial state are very simple, but that give the User the ability to penetrate into more detailed realms of design control contextually, if the User so chooses.

Contextual “drilling-in” to greater refinement of control and detail, especially using iterations of the same style of Controls that are quickly and easily accessed, gives the User the full leverage of technology to achieve design goals. The User can operate on a purely simple and broad level of design control—that is as simple as turning a knob or moving a fader and seeing what happens. But the User also has the ability to control the final product in as refined a manner as if the User was using a professional Design System.

The basis of the interface for design control in AADS is a Panel which sits on any side, or preferably along the bottom of the design object. The panel, FIG. 7, is comprised of four main sections. The first [16], indicates the current Element of the Object, such as header area, sidebar, inset, or perhaps architecture of the entire design, that the Controls of the panel will be affecting, the second [18], contains a set of icons that determine the specific Controls will appear in the Control section, [20], and that Control section in turn contains the main Controls of the panel that affect the particular facet of the selected current Element of the design, and the fourth [22], provides additional options and settings. The Controls that appear in the Control section of the Panel, [20], will change based on the selection in the Icon section of the Panel [18].

In the example of FIG. 7, the current active Element the User is working on seen to be “Header.” The User primarily will be using the icons in the Icon section [18] to determine which specific Controls in the Control section of the Panel [20] will be active, and then exploring design possibilities by manipulating those Controls, such as faders, knobs, and switches inside the that area of the Panel.

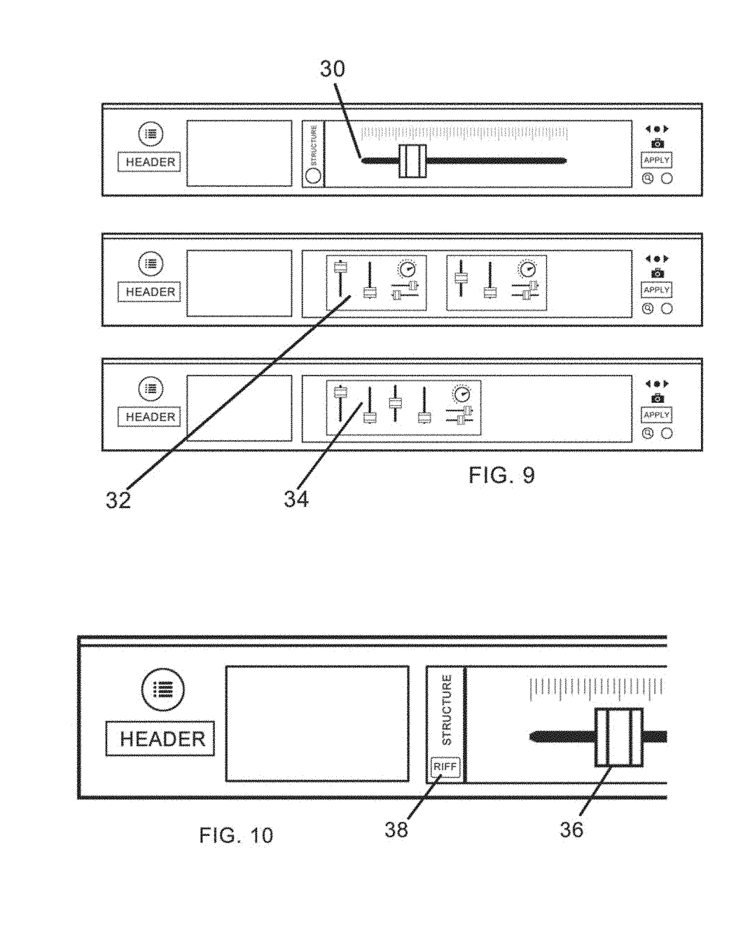

For example, if the User wishes to focus on the design of the Text of the header Element of the Object, FIG. 8, which is indicated in the first section [24], clicking on the icons in the second section [26] will bring up different panel options in the third section [28]. These subdivisions represented by the icons in the second section may be such things as Title or Subtitle (text), or perhaps an image contained in the header area of the object. Clicking on any of these icons brings up the full range of interface possibilities in the third section of the Panel. Selecting on different Icons may bring up via animation different Control sets, FIG. 9 [30], [30], [30].

The third section of the Panel is where the actual Controls that affect the Elements of the design are found. In each panel subdivision brought up by clicking on the icons of the second section, the User is generally provided with a single simple Control, such as a fader. This single Control has various increments along its field of movement, or axis, that provides the User with coordinated broad changes to an Element, that may include the adjustment of multiple attributes of that Element at once. For example, if the User has selected the “Title” icon, bringing up the Control set in the Control section of the Panel that would be affecting specifically the title text of the header Element of the design, FIG. 10 [36], the fader may affect font size, letter-spacing, and the color of the text all at once. As the User glides along the path of this fader the title text instantaneously and fluidly changes its appearance across these multiple attributes.

If the User chooses to drill in and work in a more refined setting on the title text, clicking on the button, in this example titled “riff,” [38], an animated movement of that main fader now reveals a bank of sub faders that operate on and affect the individual attributes that had been tied together into that original control. The User can now find the setting of each and every attribute of that Element, and thus has the ability sculpt a more precise arrangement of any design element, and ultimately arrive at an overall design of the User's aesthetic choice.

Live Nested Controls

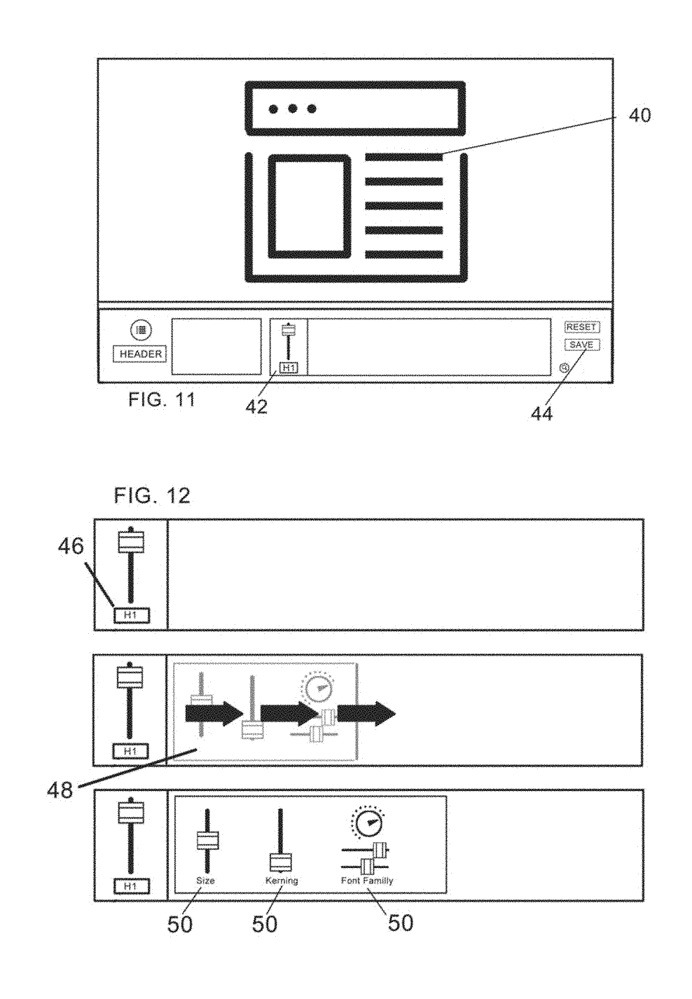

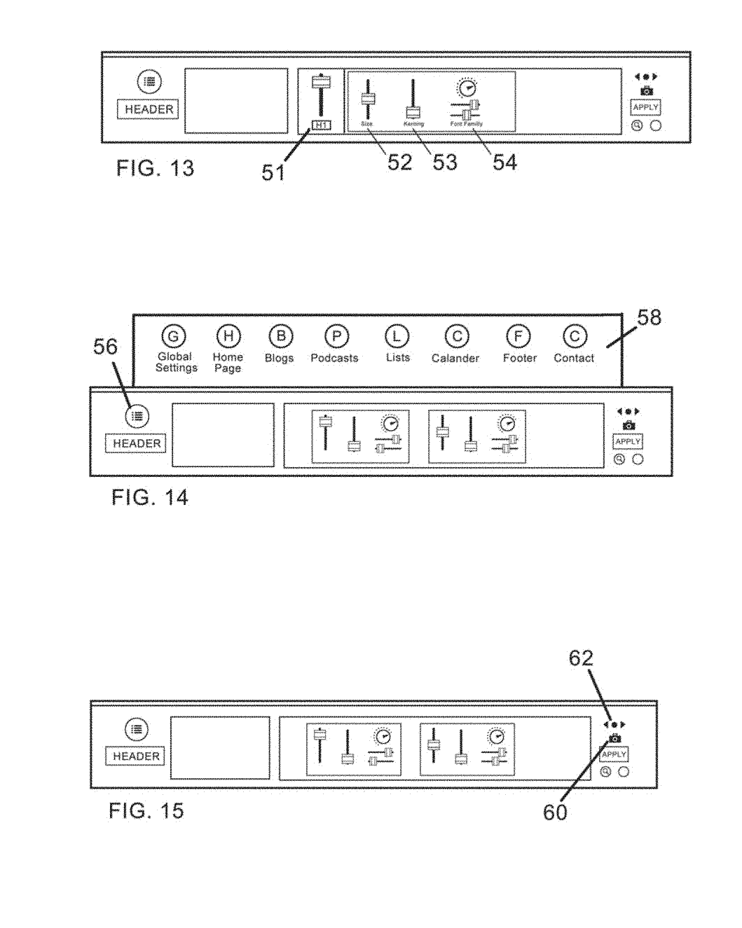

An example of another embodiment brings us to an even more powerful use of nested controls. In this example the user is going to work on the main header font style FIG. 11. [40], i.e. change its font family, size, kerning, color, boldness etc. This “Header 1” style is referred to in this embodiment as “H1.” The panel may initially have a single control in the main control area, [42] which is labeled “H1” to indicate that this single control manipulates multiple attributes of the “Header 1” font style. It may simultaneously change the font family, the size, the line height, etc., giving the user a number of options as the slider is moved up and down along its axis.

This may very well provide the user with the desired options, in which case wood click the save button [44], and the styling of the header font would be complete. If, however, the User clicks wants greater control over this font style, a single click on the “H1” label under the control, FIG. 12 [46] causes all of the controls that were tied to that single fader, “Sub Faders,” to be folded out in animated fashion [48] and fully revealed for the user's manipulation [50].

Now continuing to manipulate the master fader [51], the user sees all of the Sub Faders [52], [53], [54] that have folded out to the right of the master fader, and that are still linked thereto, move of their own accord in concert with the movement of the master fader. The user may also optionally move any individual Sub Fader to see only that attribute of the H1 element (e.g. size [52]) being altered. In this way, the user has an easy single control to manipulate multiple attributes of an element, but at any point can also “drill in” to manipulate any individual attribute, or in other embodiments, elements.

Using Controls for the Styling of Content

Styling of the design is not limited to the overarching design of the Object. Individual components (a “Component” is any predefined construct within an Object) that are manifest within the overall design may also be styled using the panel interface. For example, again using the example of the website, the styling of lists, forms, forums, calendars, or any other Component that may sit inside the website design, can be accomplished using the same Control paradigm. A number of the Element Icons in the Tray represent these Elements. For example, one of the Element Icons in the Tray is for “Calendar.”

Calendars are design Elements just like any other, and there possible attributes are catalogued in the same database with all other Elements. Therefore upon arrival at the “Calendar” Element, the User is presented with the usual top-level Control that contains a number of presets along its axis that represent different permutations of design for that Element. Drilling in the usual manner gives finer control over individual Elements, such as the date number font, size, color, etc.

Secondary Panel, or “Tray”

Jumping between various regions or domains of design within one larger design Object, can be accomplished using the icon, “Element Icon,” FIG. 14. [56], in the first section of the panel. For example if the User is finished styling the design of the header, and wants to move to styling a Component, such as the calendar Component of the website, clicking on the header icon in section 1, reveals a secondary panel, [58], in the preferred embodiment appearing by way of upward sliding animation to rise up from behind the main panel, that we will call herein, “Tray,” which will allow the User to click on any other domain of styling.

Upon arriving at any other design Element, the tray [58] is closed by way of downward animation and disappears behind the main panel, and again the panel is reset to reveal only the topmost simple fader that contains the preset bundled possibilities for that Element. In this manner the User is able to navigate from Element to Element and manipulate the design of each.

Mapping Images to Controls

Another powerful possible use of this interface system is to allow the User to map a folder of uploaded images (in the example of a website) to a single Control, such as a fader. The principal advantage of the use of the Control to scroll through images, is that it allows the User to sit back and simply move a single Control and observe the various image candidates for that place in the design.

Snapshot Saving

In the course of the design process it is very useful to be able to save certain states along the way for future reference, or to “bookmark” certain points in the design evolution. The User may want to save a certain state as a candidate for the final design, and be able to compare that to other possibilities that emerge during design exploration.

We provide a means by which the User can save the state of the design at any point. In one iteration of the interface, we have a snapshot button in section 4 of the panel, FIG. 15 [60], which preserves precisely the state of the design of the instant the button is clicked. Since the entire design is a function of the state of all Controls, what is actually happening in the snapshot is simply the recording of the position of all Controls.

The User need not do anything other than simply click the “snap” button [60] at any point the User wishes to save a certain setting. That setting is added as the last item in the growing list of Control snapshots. That list can then be mapped to a Control, such as a fader. The User can then call up the snapshot Control, in the preferred embodiment using the button shown, [62] and then scroll back and forth using that Control whereupon all previously saved designs are instantaneously recalled.

Example of Use

In this example we will use a website, “Website,” as the example of the Object to be designed, but the design Object could just as easily be any other medium such as business card or brochure. This example also represents but one embodiment of this invention.

The User begins in a “design search” area of the Design System, by setting a series of Controls such as faders, each fader representing a point along a spectrum or axis of possible attributes, such as simple vs. complex, light vs dark, or any other possible attribute.

Upon clicking the submit button the User is then presented, with a series of thumbnails of designs that are imbued with the attribute choices selected in the previous interface. Multiple pages of additional thumbnails are also available via navigation buttons.

The User may return to the attribute selection interface to refine their attribute selections, Or the User may click on any thumbnail to immediately bring up the full website design.

Upon arrival at the design, the User is presented both with the full page Website and a panel below it with Controls that enable manipulation of the Elements of the Website design.

The User is encouraged to freely explore each area of the design.

Each area of the design, such as header area, has its own domain of Controls. Clicking on Element Icon in the panel, which causes the Tray to be revealed animated rising up from behind the Panel, further revealing additional Element Icons. Clicking on any of these Element Icons causes a different set of controls to load, which will focus on the Element that was selected. Each time a new set of controls loads, the User is first greeted with a top level Control such as a single fader that contains preset combinations of attributes of each object.

If, for example, the User selected “header area” the appropriate panel for that Element would be loaded and the initial single Control, in this case a horizontally arranged fader would appear in the third section of the panel. Moving the fader along this axis reveals significant and broad changes to the header Element. The font of the header text a move; the background image if there is one may change; borders and lines if there are any may be altered in their thickness or stylistic effect.

if the User arrives at a position on that Control that brings the header design close to the desired look for this Element, the option exists for the User to click on a button near to the fader, which causes the main fader to be animated upward and replaced by multiple sub faders in that space in the Panel. The User may now manipulate these finer Controls that appear in the Panel. The User will find these Controls are now manipulating more finally resolved attributes of the Element.

For example whereas the initial simple fader that appeared manipulated all the attributes discussed above, these sub faders or other Controls are manipulating one or only of certain group of attributes of this Element, such as the header text alone. This fader, however, may be affecting multiple attributes of only the header text. The User may wish to focus in on a single attribute of the header text. Again a button is provided underneath that particular fader, which when clicked again animates additional sub faders to be revealed providing even finer granularity of control over the design. Clicking on any of those initial buttons closes out the sub faders and animates the panel back to more general faders that were seen originally.

By this process, the design can be altered in substantial movements with simple Controls, or finer movements with more complex arrangements of Controls.

In one embodiment AADS is integrated into a Content Management System, or CMS wherein all content is saved in the database separate and distinct from any and all design considerations. This includes all hand-entered content, any Components such as calendars, lists, forms, etc., and their data, as well as any images or other media added to the designed by the User. This means that at any time the design can be completely altered without affecting any of the content whatsoever. The User, for example, could return to the design search page, and indeed start over from scratch on the design, leaving the content untouched.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A device for the development of a webpage, comprising:
a. the ability of a user to select a design attribute using a panel of controls that represent points along an axis;
b. the device returning one or more design candidates based on the selected design attribute;
c. the design candidates being adjustable by a variety of design factors that result in a predetermined aesthetically coordinated manner;
d. two or more of the design candidates being tied together for manipulation simultaneously by a single control on the panel of controls
e. the single controls that simultaneously manipulates two or more design candidates has a sub-control to manipulate individual design candidates independent of the two or more design candidates;
f. conversion of one or more configuration files that defines the arrangement the panel of controls is converted into an interactive panel for the end user;
g. a database for the design candidates where the design candidates are organized and identified by both qualitative and quantitative attributes for attribute-oriented design candidate searching; and
h. a second database for the input and storage of information pertaining to a homepage of the webpage.

2. The device as in Claim 1 wherein the panel of controls are digital renderings of faders, knobs, switches, and various other interface controls on one or more digitally rendered panels.

3. The device as in claim 1 wherein user manipulation of the panel of controls updates a global state that in turn updates a style change into the webpage.

4. The device as in claim 1 wherein the device saves a snapshot of the current state of the design for later retrieval and further manipulation.

5. The device as in claim 1 wherein the user can map and manipulate custom images to the webpage design.

6. The device as in claim 1 wherein there is a page management system that reflects a menu architecture of the webpage.

7. The device as in claim 1 wherein fonts on the webpage may be manipulated globally using the panel of controls.

8. The device as in claim 1 wherein there is a reveal panel area that displays attribute information that is stored in one or more of the databases of the one or more currently selected design candidates.

9. A method of designing digital or print media, comprising:
a. the ability of a user to select a design attribute using a panel of controls that represent points along an axis;
b. returning one or more design candidates based on the selected design attribute;
c. the design candidates being adjustable by a variety of design factors that result in a predetermined aesthetically coordinated manner; and
d. two or more of the design candidates being tied together for manipulation simultaneously by a single control on the panel of controls.

10. The method as in claim 9 wherein the panel of controls are digital renderings of faders, knobs, switches, and various other interface controls on one or more digitally rendered panels.

11. The method as in claim 9 wherein user manipulation of the panel of controls updates a global state that in turn updates a style change into the digital or print media.

12. The method as in claim 9 wherein conversion of one or more configuration files that defines the arrangement the panel of controls is converted into an interactive panel for the end user.

13. The method as in claim 9 wherein the single controls that simultaneously manipulates two or more design candidates has a sub-control to manipulate individual design candidates independent of the two or more design candidates.

14. The method as in claim 9 wherein the device saves a snapshot of the current state of the design for later retrieval and further manipulation.

15. The method as in claim 9 wherein the user can map and manipulate custom images to the digital or print media design.

16. The method as in claim 9 wherein there is a database for the design candidates where the design candidates are organized and identified by both qualitative and quantitative attributes for attribute-oriented design candidate searching.

17. The method as in claim 9 wherein there is a page management system that reflects a menu architecture of the digital or print media.

18. The method as in claim 9 wherein there is a second database for the input and storage of information pertaining to a homepage of the digital or print media.

19. The method as in claim 9 wherein fonts on the digital or print media may be manipulated globally using the panel of controls.

20. The method as in claim 9 wherein there is a reveal panel area that displays attribute information that is stored in one or more of the databases of the one or more currently selected design candidates.
